(19) United States
(12) Patent Application Publication
(10) Pub. No.: US 2017/0253256 A1
(43) Pub. Date: Sep. 7, 2017

(54) SLIDING DOOR

(71) Applicant: SIEMENS AKTIENGESELLSCHAFT, MUNICH (DE)

(72) Inventor: AXEL KRUEGER, KREFELD (DE)

(21) Appl. No.: 15/504,966

(22) PCT Filed: Aug. 24, 2015
(86) PCT No.: PCT/EP2015/069333

§ 371 Date: Feb. 17, 2017

(30) Foreign Application Priority Data
Aug. 29, 2014 (DE) 10 2014 217 343.4

(51) Int. Cl. B61D 19/02; E06B 7/23

(52) U.S. Cl. CPC B61D 19/02; E06B 7/2307

(57) ABSTRACT

A sliding door has at least one door leaf that can be brought into an open and a closed position by sliding the door leaf. The sliding door is provided with at least one spring which, in the closed position of the siding door, presses a sealing lip of a seal mounted on the door leaf against a sealing surface on the frame. The sealing lip thereby seals the sliding door from the outside.

The invention relates to a sliding door comprising at least one door leaf which can be brought into an open and a closed position by the displacement thereof, and to vehicles which are provided with such sliding doors.

For example, sliding pocket doors are known from S-Bahn carriages of the Berlin S-Bahn of the ET 165 type (later series 275 of the East German Railways and/or 475 of the German Federal Railways). Due to their construction the door leaves of these sliding pocket doors are not able to close flush with the external vehicle wall of the S-Bahn carriages but have to be arranged offset to the inside. This offset to the rear leads to air turbulence and dynamic pressures. These two effects may result in external air is which has not been temperature-controlled entering the vehicle interior, the vehicle air conditioning being impaired and the noise level increasing in the vehicle interior. The more quickly the vehicle travels, the more serious this effect becomes. In S-Bahn carriages of the ET 165 type these problems do not occur and/or did not occur or at least not significantly, since the S-Bahn carriages only travel and/or traveled at relatively low speed.

Accordingly, the object of the invention is to specify a sliding door which has an improved sealing action relative to previous sliding doors and which, in particular, may be used in vehicles traveling rapidly.

This object is achieved according to the invention by a sliding door having the features as claimed in claim 1. Advantageous embodiments of the sliding door according to the invention are disclosed in the subclaims.

Accordingly, it is provided according to the invention that the sliding door comprises at least one spring which, in the closed position of the sliding door, presses a sealing lip of a seal mounted on the door leaf against a sealing surface on the frame, said sealing lip sealing the sliding door from the outside.

A substantial advantage of the sliding door according to the invention may be seen to be that the spring which is present significantly increases the sealing action of the sealing lip as a whole. By the additional contact force of the spring, a sufficient sealing action of the seal and a sufficient seal of the sliding door may be achieved overall even when the sliding door is used in vehicles, in particular rail vehicles, which travel rapidly.

Relative to the arrangement of the seal and the spring, it is seen as advantageous if both the seal and the spring are attached to a rear edge of the door leaf to be sealed.

Relative to the design of the spring it is regarded as advantageous if said spring is formed by a sheet metal spring, in particular a sheet metal spring made of spring steel.

Preferably, the sealing lip or the seal as a whole consists of rubber.

In view of an optimal spring action of the spring, it is regarded as advantageous if the spring has a plurality of through-holes, in particular stamped-out portions, which are arranged spaced apart from one another when viewed in the longitudinal direction of the sealing lip. The through-holes preferably separate a connecting web of the spring from a spring base body of the spring. The arrangement and size of the through-holes determine the flexibility of the connecting web relative to the spring base body and thus the spring action of the spring relative to the seal. The connecting web, the outer web edge thereof preferably being straight, is preferably located parallel to the sealing lip end of the sealing lip of the seal.

A local adaptation of the spring action of the spring may be achieved if the size of the through-holes and/or the spacing thereof to one another is variable and/or varied along the connecting web.

Alternatively or additionally, it may be provided that the spring has a comb-like structure with spring tines which extend away from a spring base body of the spring in the direction of the sealing lip end of the sealing lip. A is local adaptation of the spring action of the spring is preferably achieved by the spacing of the spring tines and/or the width of the spring tines being variable and/or varied along the comb-like structure.

For fastening the spring, in particular for fastening the spring to the seal, the spring preferably has fastening holes. The fastening holes are preferably provided in the spring base body of the spring.

For fastening the spring, preferably at least one screw element is provided, preferably in the form of a screw, by which the spring is screwed to the seal. The screw elements and/or screws are in each case preferably passed through one of the fastening holes in the spring base body of the spring.

Relative to the screw connections, it is regarded as advantageous if in each case a spacer element comprising a thread is inserted into a recess of the seal, the screw is screwed to the spacer element and a portion of the seal and a portion of the spring are clamped between the spacer element and the screw head of the screw. The recess into which the spacer element is inserted is preferably formed by a groove which is located parallel to the sealing lip end of the sealing lip of the seal and/or parallel to the outer web edge of the connecting web.

Relative to the mounting of the seal on the door leaf, it is regarded as advantageous if the seal is latched and/or clamped in a receiver portion of the sliding door on the door side by means of a positive connecting portion.

The sliding door is preferably a sliding pocket door.

The invention further relates to a vehicle which is is provided with a sliding door. According to the invention, it is provided relative to such a vehicle that the sliding door is configured as described above.

The vehicle is preferably a rail vehicle.

The invention is described in more detail hereinafter with reference to exemplary embodiments; in which by way of example

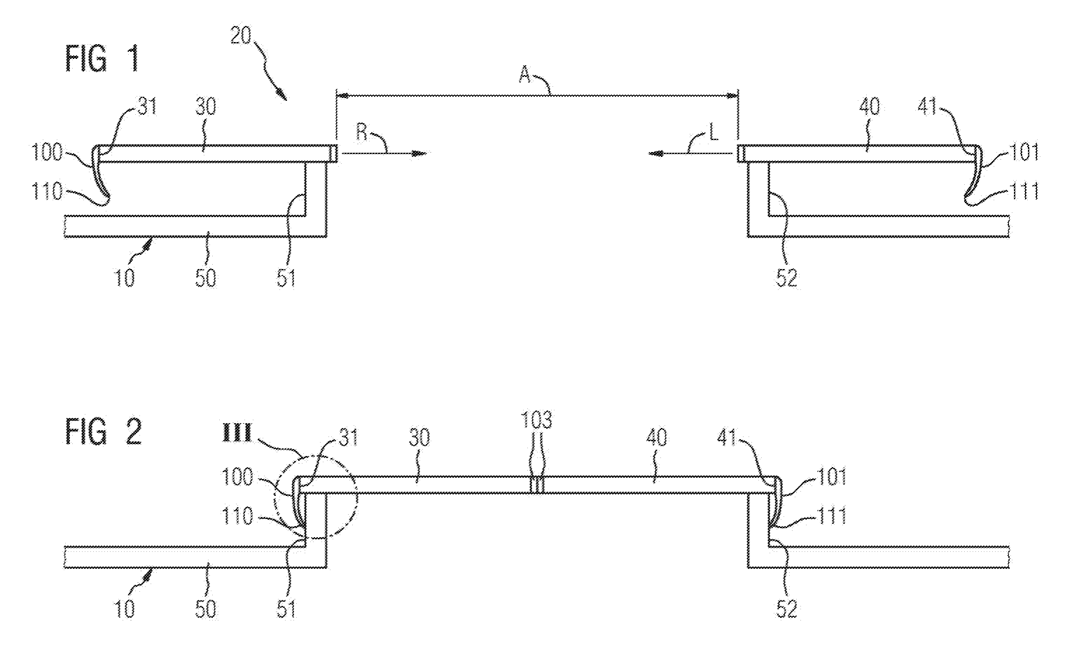

FIG. 1 shows an exemplary embodiment of a sliding door according to the invention which is mounted in a rail vehicle, wherein FIG. 1 shows the open position of the sliding door,

FIG. 2 shows the sliding door according to FIG. 1 in the closed state,

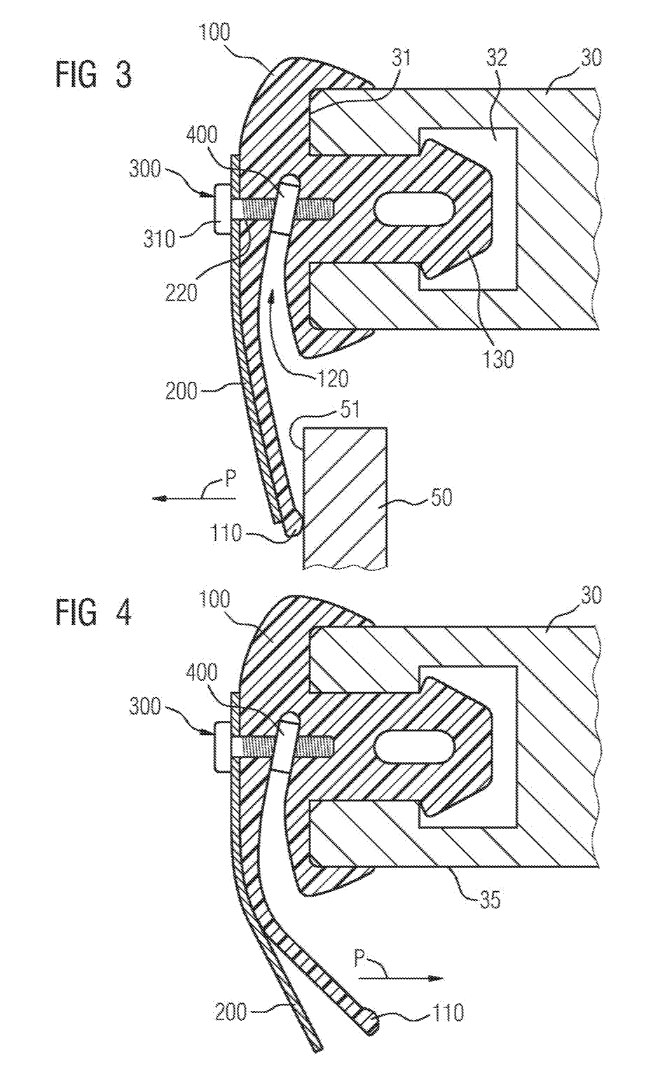

FIG. 3 shows the detail marked by the reference numeral III in FIG. 2 in cross section in more detail, wherein the mode of operation of a spring acting on a seal on the door leaf side—in the closed position of the sliding door—may be identified,

FIG. 4 shows the detail according to FIG. 3 for further explanation, in the open position of the sliding door,

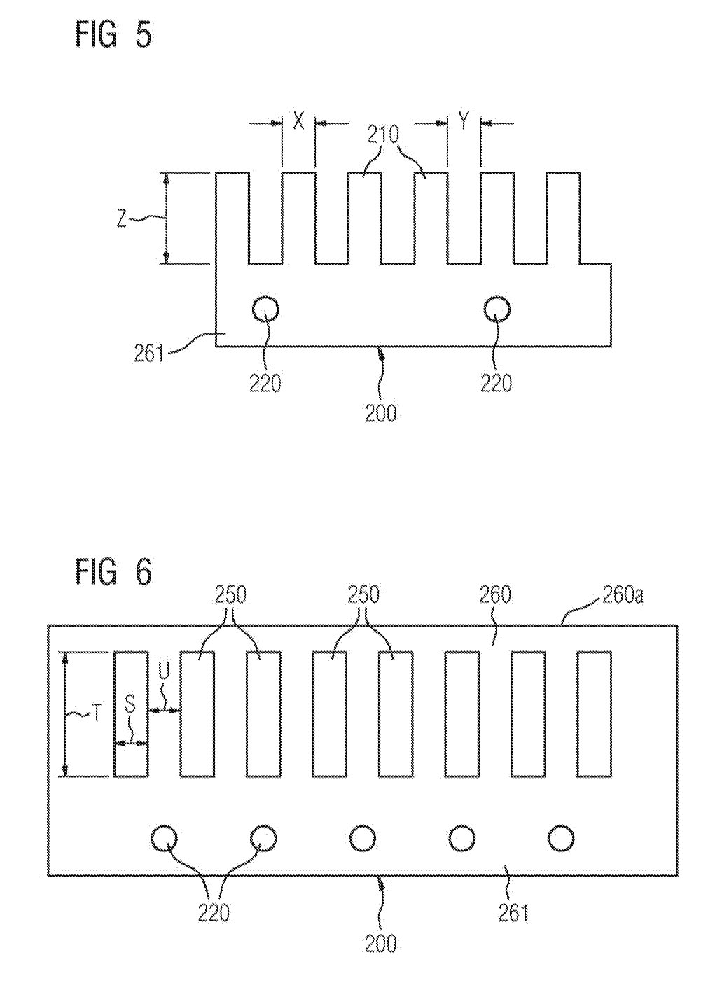

FIG. 5 shows an exemplary embodiment of a spring as may be used in the sliding door according to FIGS. 1 to 4, in more detail and

FIG. 6 shows a further exemplary embodiment of a spring which may be used in the sliding door according to FIGS. 1 to 4.

For the sake of clarity, the same reference numerals are always used in the figures for components which are is identical or similar.

FIG. 1 shows in a view from above an exemplary embodiment of a sliding door 10 which is mounted in a rail vehicle 20, not shown further. The sliding door 10 comprises two door leaves 30 and 40 which may be transferred from the open position shown in FIG. 1 into their closed position by being displaced in the direction of the arrow R and/or the direction of the arrow L. The clearance width of the open sliding door 10 is identified in FIG. 1 by the reference numeral A.

It may be seen in FIG. 1 that the left-hand door leaf 30 in FIG. 1 is provided with a seal 100 which is mounted in the region of the rear edge 31 and/or on the rear edge 31 of the door leaf 30. The seal 100 comprises a sealing lip 110 which protrudes from the plane of the door leaf 30 and thus is able to cooperate in the closed position of the door leaf 30 with a sealing surface 51 on the frame side of a door frame 50 of the sliding door 10.

In order to permit a corresponding seal of the door leaf 40 in the closed position, the door leaf 40 is also provided with a seal 101 which is mounted in the region of the rear edge 41 of the door leaf 40 and/or on the rear edge 41 of the door leaf 40. The seal 101 mounted on the door leaf 40 comprises a sealing lip 111 which protrudes from the plane of the door leaf 40 and thus is able to cooperate with a sealing surface 52 on the frame side of the door frame 50 is when the door leaf 40 is transferred from the open position shown in FIG. 1 into its closed position.

FIG. 2 shows the sliding door 10 according to FIG. 1 in its closed position. It may be identified—starting from the view according to FIG. 1—that the left-hand door leaf 30 has been displaced to the right in the direction of the arrow R and the right-hand door leaf 40 has been displaced to the left in the direction of the arrow L and the two door leaves bear against one another with their front faces. The front faces are preferably provided at the front with seals which are indicated in FIG. 2 by the reference numeral 103.

Moreover, FIG. 2 enables the mode of operation of the two seals 100 and 101 to be seen, said seals being attached to the rear edges 31 and/or 41 of the two door leaves 30 and 40. Thus FIG. 2 shows that the sealing lips 110 and 111 in each case bear against the sealing surface 51 and/or 52 of the door frame 50 assigned thereto on the frame side and thus seal the sliding door 10 in the region of the rear edges 31 and 41 of the door leaves 30 and/or 40 in the closed door position.

In order to ensure a particularly effective sealing action of the seals 100 and 101 even when the rail vehicle 20 is traveling—in particular a sealing action which considerably exceeds that in sliding pocket doors of rail vehicles of the series of the ET 165 type mentioned in the introduction—the sealing lips 110 and 111 of the two seals 100 and 101 are pressed against the associated sealing surface 51 and/or 52 on the frame side, in each case by means of a spring. The mode of operation of these springs is described in more detail hereinafter in connection with FIG. 3 which shows the detail of the sliding door 10 in more detail marked by the reference numeral III in FIG. 2.

In FIG. 3 the door leaf 30 with its seal 100 is shown in more detail in a cross section. It may be identified that a spring in the form of a sheet metal spring, preferably a sheet metal spring made of spring sheet steel, bears against the seal 100. The spring 200 is screwed by means of a screw 300 and a spacer element 400 (for example in the form of a nut) to the seal 100. To this end the spacer element 400 is inserted into a groove-shaped recess 120 of the seal 100, so that the screw 300 is able to be screwed in the position and/or manner shown in FIG. 3. By screwing the screw 300, the spring 200 is clamped between the screw head 310 and the seal 100.

The function of the spring 200 is to press the sealing lip 110 protruding from the plane of the door leaf 30 in FIG. 3 to the right and/or in the direction of the rear edge 31 of the door leaf 30, so that when reaching the closed position of the sliding door 10 the sealing lip 110 bears with a particularly high contact pressure on the associated sealing surface 51 on the frame side.

The position of the sealing lip 110 shown in FIG. 3 and the spring 200 is thus achieved only by deformation of the spring 200 and namely when—in the closed position of the door leaf 30—the sealing lip 110 and the spring 200 are forced away to the left by the sealing surface 51 on the frame side in the direction of the arrow P in FIG. 3.

FIG. 3 also shows the mounting of the seal 100 on the rear edge 31 and/or the door leaf 30 in more detail. It may be identified that in the region of its rear edge 31 the is door leaf 30 is provided with a receiver portion in the form of a recess 32, preferably in the form of a fastening groove. A positive connecting portion 130 of the seal 100 is is forced into the recess 32, as a result said seal being retained both by means of a positive connection and by means of clamping and/or a frictional connection on the rear edge 31 and/or in the region of the rear edge 31 on the door leaf 30.

The seal 101 on the door leaf 40 (see FIGS. 1 and 2) is preferably of the same construction as the seal 100 on the door leaf 30 and is preferably also acted upon by the spring force of a spring; this spring is preferably of the same construction as the spring 200 attached to the door leaf 30. The above embodiments, in combination with the seal 100 of the door leaf 30 and the spring 200, thus accordingly apply to the seal 101 of the door leaf 40 according to FIGS. 1 and 2.

FIG. 4 shows the function of the spring 200 according to FIG. 3 in the open state of the door leaf 30. It may be seen that, due to the spring force of the spring 200, the sealing lip 110 has been pivoted to the right in the direction of the arrow P in FIG. 4, and as a result partially protrudes into the side wall region of the side wall 35 of the door leaf 30 and/or in the view according to FIG. 4 into the region below the side wall 35 of the door leaf 30.

If—starting from the open position of the door leaf 30 according to FIG. 4—the door leaf 30 is closed, the sealing lip 110 when striking the sealing surface 51 of the door frame 50 on the frame side (see FIGS. 1 to 3) is pivoted counter to the direction of the arrow P in FIG. 4 is and subsequently due to the spring force of the spring 200 is pressed against the sealing surface 51 on the frame side, as has been explained above in connection with FIG. 3.

FIG. 5 shows an exemplary embodiment of a spring 200 which may be used in the sliding door 10 according to FIGS. 1 to 4. The spring 200 according to FIG. 5 is formed by a spring steel sheet which has a comb-like structure and on the edge has spring tines 210, which in the mounted state of the spring 200 protrude from a spring base body 261 of the spring 200 in the direction of the sealing lip end of the sealing lip 110 and/or 111 (see FIGS. 3 and 4).

The width X of the spring tines 210, the spacing Y between the spring tines 210 and the length Z of the spring tines 210 establish the flexibility of the spring 200 and are selected such that the spring action 200 described in connection with FIGS. 3 and 4 for pressing the sealing lips 110 and/or 111 onto the assigned sealing surface 51 and/or 52 of the door frame 50 (see FIG. 1) as explained above, may be implemented with sufficient contact pressure even when the rail vehicle 20 is traveling rapidly (for example at speeds of over 120 km/h).

FIG. 5 also shows fastening holes 220 which permit the screw 300 to be passed through for the purpose of screwing the spring 200 to the seal 100 (see FIGS. 3 and 4). The fastening holes 220 are preferably arranged in the spring base body 261 of the spring 200.

FIG. 6 shows a further exemplary embodiment of a spring 200 which may be used in the sliding door 10 according to FIGS. 1 to 4. The spring 200 according to FIG. 6 is is provided with through-holes 250 in the form of stamped-out portions, the size and arrangement thereof determining the flexibility of the spring 200.

The through-holes 250 are preferably arranged spaced apart from one another in the longitudinal direction of the sealing lip 110 and/or 111 (see FIGS. 3 and 4). The through-holes 250 separate an outer connecting web 260 from a spring base body 261 of the spring 200. The connecting web 260 has an outer web edge 260a which is straight and located parallel to the sealing lip end of the sealing lip 110 and/or 111 of the seal 100 and/or 101 (see FIGS. 3 and 4).

The width S and the length T of the through-holes 250 and the spacing U between the through-holes 250 are preferably selected such that the spring force of the spring 200 is able to exert onto the seal 100 and/or 101 sufficient contact force for the sealing, even when the rail vehicle 20 is traveling rapidly (for example at speeds of over 120 km/h), as has been already explained above in detail in connection with FIGS. 3 and 4.

FIG. 6 also shows fastening holes 220 which permit the spring 200 to be screwed, according to FIG. 6, by means of the screws 300, according to FIGS. 3 and 4, on the seal 100 and/or 101. The fastening holes 220 are preferably arranged in the spring base body 261 of the spring 200.

Whilst the invention has been illustrated and described in more detail by preferred exemplary embodiments, the invention is not limited by the disclosed examples and other variants may be derived therefrom by the person skilled in the art without departing from the protected scope of the invention.

1-13. (canceled)

14. A sliding door, comprising:
at least one door leaf disposed for sliding displacement relative to a frame between an open position (FIG. 1) and a closed position (FIG. 2);
a seal mounted on said at least one door leaf;
a spring disposed, in the closed position of the sliding door, to press said sealing lip of said seal against a sealing surface on said frame for outwardly sealing the sliding door.

15. The sliding door according to claim 1, wherein said seal and said spring are attached to a rear edge of said at least one door leaf.

16. The sliding door according to claim 14, wherein said at least one spring is a sheet metal spring made of spring steel sheet.

17. The sliding door according to claim 14, wherein said sealing lip consists of rubber.

18. The sliding door according to claim 14, wherein said seal consists of rubber.

19. The sliding door according to claim 14, wherein said spring is formed with a plurality of through-holes.

20. The sliding door according to claim 19, wherein said through-holes are stamped-out portions spaced apart from one another when viewed in the longitudinal direction of said sealing lip and located between a web edge of a connecting web of said spring located parallel to said sealing lip and a spring base body of said spring.

21. The sliding door according to claim 14, wherein said spring has a comb-like structure with spring tines protruding in a direction of a sealing lip end of said sealing lip.

22. The sliding door according to claim 21, wherein a spacing between said spring tines and/or a width of said spring tines along the comb-like structure is variable.

23. The sliding door according to claim 14, wherein said spring is screwed to said seal by way of a screw.

24. The sliding door according to claim 23, wherein:
wherein said seal is formed with a groove-shaped recess and a spacer element with a thread is inserted into said recess;
said screw is screwed to said spacer element; and
a portion of said seal and a portion of said spring are clamped between said spacer element and a screw head of said screw.

25. The sliding door according to claim 14, wherein said seal is latched and/or clamped in a receiver portion of said door leaf on a door side.

26. The sliding door according to claim 25, wherein said seal is latched and/or clamped in the receiver portion of said door leaf by way of a positive connecting portion.

27. The sliding door according to claim 14, configured as a sliding pocket door.

28. A vehicle, comprising at least one sliding door according to claim 14.

29. The vehicle according to claim 28, the vehicle being a rail vehicle.
